(19) United States
(12) Patent Application Publication
(10) Pub. No.: US 2020/0395798 A1
(43) Pub. Date: Dec. 17, 2020

(54) Rotor for Spoke Motor

(71) Applicant: Komotek Co., Ltd., Seongnam-si (KR)

(72) Inventors: Deok Geun Kim, Seongnam-si (KR); Yun Yong Song, Seongnam-si (KR); Hong Soon Choi, Yongin-si (KR); Chang Hoon Seok, Daegu (KR)

(21) Appl. No.: 16/901,805

(22) Filed: Jun. 15, 2020

(30) Foreign Application Priority Data
Jun. 17, 2019 (KR) 10-2019-0071845

(51) Int. Cl. H02K 1/27; H02K 1/28; H02K 21/14; H01F 1/057

(52) U.S. Cl. CPC H02K 1/278; H01F 1/057; H02K 21/145; H02K 1/28

(57) ABSTRACT

Disclosed is a rotor for a spoke motor, in which both rare-earth magnets and ferrite magnets are arranged in series, the rare-earth magnet has a smaller size than the ferrite magnet, and a small amount of rare-earth magnet is used, such that manufacturing costs may be greatly reduced, an efficient output may be produced, the motor may produce a higher output than a spoke motor model using only the ferrite magnet, and the motor may use a smaller amount of rare-earth magnet than an IPM type motor model, but may produce an output at a similar level to that of the IPM type motor model.

### CROSS-REFERENCE TO RELATED APPLICATION

This application claims priority to Korean Patent Application No. 10-2019-0071845 filed Jun. 17, 2019, the disclosure of which is hereby incorporated by reference in its entirety.

### TECHNICAL FIELD

The present invention relates to a rotor for a spoke motor and, more particularly, to a rotor for a spoke motor in which both rare-earth magnets and ferrite magnets are arranged in series, the rare-earth magnet has a smaller size than the ferrite magnet, and thus a small amount of rare-earth magnet is used, such that manufacturing costs may be greatly reduced, and an efficient output may be produced.

### BACKGROUND ART

Types of permanent magnets used for motors are broadly classified into ring-type permanent magnets and segment-type permanent magnets.

The segment-type permanent magnet is mainly used for a motor having a large capacity because the ring-type permanent magnet is vulnerable in terms of strength.

Depending on shapes of magnets and application positions of magnets, rotors using the segment-type magnets are classified into a surface permanent magnet (SPM) type rotor and an interior permanent magnet (IPM) type rotor.

The SPM may use only magnetic torque created by the permanent magnet, whereas the IPM may use both magnetic torque created by the permanent magnet and reluctance torque created by a concave-convex shape of an iron core and thus is used where high torque is required.

The IPM type rotors may be classified into several types of rotors depending on a shape in which permanent magnets are inserted into an iron core. Among others, a spoke motor, in which the iron core and the permanent magnet are alternately disposed, may use the most reluctance force and generate the highest torque among the IPMs.

In general, a motor for an electric vehicle requires properties such as high-power density, a wide range of driving speed, and high efficiency. These properties are well satisfied by a synchronous motor using rare-earth magnets.

However, because the rare-earth magnet made of neodymium (Nd), dysprosium (Dy), and the like are very expensive, there is a tendency to design a motor by not using the rare-earth magnet or by reducing the amount of rare-earth magnet to be used.

One of the methods of reducing the amount of rare-earth magnet to be used is to use both the rare-earth magnet and a ferrite magnet different from the rare-earth magnet.

However, because coercive force and residual magnetic flux density of the ferrite magnet are as low as ⅓ of those of the rare-earth magnet, the distribution of lines of magnetic force needs to be considered when the ferrite magnet, together with the rare-earth magnet, is used for a rotor of a motor.

Because a general spoke motor uses the ferrite magnet, it is difficult to produce a high output.

[Document of Related Art]

[Patent Document]

(Patent Document 1) Korean Patent Application Laid-Open No. 10-2009-0079777

### SUMMARY OF THE INVENTION

The present invention has been made in an effort to provide a rotor for a spoke motor, in which both rare-earth magnets and ferrite magnets are arranged in series, the rare-earth magnet has a smaller size than the ferrite magnet, and a small amount of rare-earth magnet is used, such that manufacturing costs may be greatly reduced, and an efficient output may be produced.

In order to achieve the above-mentioned object, a rotor for a spoke motor according to the present invention includes: a rotor core disposed in a stator; and the rotor in which rare-earth magnets and ferrite magnets are arranged in series so as to be inclined at a predetermined angle with respect to a central shaft of the rotor core to form one motor pole, in which the rare-earth magnet is disposed adjacent to the central shaft, and the ferrite magnet is disposed adjacent to an air gap formed between the rotor and the stator, in which N-pole magnets or S-pole magnets, which are configured by the rare-earth magnets and the ferrite magnets of the rotor, are alternately arranged to have a tornado shape, in which the rare-earth magnet has a smaller size than the ferrite magnet, and in which a first bridge, which is a space made as one end surface of the rare-earth magnet and one end surface of the ferrite magnet are spaced apart from each other at a predetermined distance, is formed.

According to the above-mentioned configuration of the present invention, the motor may produce a higher output than a spoke motor model using only the ferrite magnet, and the motor may use a smaller amount of rare-earth magnet than an IPM type motor model, but may produce an output at a similar level to that of the IPM type motor model.

According to the present invention, it is possible to reduce the number of bridges in comparison with the general IPM type motor and thus to reduce a magnetic leakage, thereby improving efficiency of the magnet.

According to the present invention, the use of a small number of (three) bridges and a small amount of rare-earth magnet may greatly reduce manufacturing costs, produce an efficient output, and reduce magnetic leakage flux.

### BRIEF DESCRIPTION OF THE DRAWINGS

FIG. 1 is a view illustrating a configuration of a spoke motor according to an exemplary embodiment of the present invention which includes a combination of ferrite magnets and rare-earth magnets.

FIG. 2 is an enlarged view of a partial region of the spoke motor according to the exemplary embodiment of the present invention which includes the combination of the ferrite magnets and the rare-earth magnets.

FIG. 3 is a view illustrating a magnetic flux loop of a magnetic circuit of the spoke motor according to the exemplary embodiment of the present invention which includes the combination of the ferrite magnets and the rare-earth magnets.

FIG. 4 is a view illustrating lengths and widths of the ferrite magnet and the rare-earth magnet according to the exemplary embodiment of the present invention.

### DETAILED DESCRIPTION

Throughout the specification, unless explicitly described to the contrary, the word “comprise/include” and variations such as “comprises/includes” or “comprising/including” will be understood to imply the inclusion of stated elements, not the exclusion of any other elements.

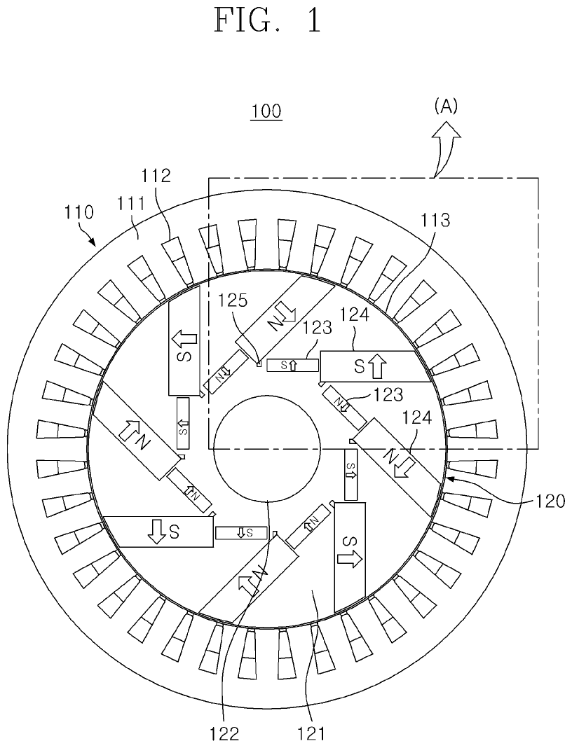

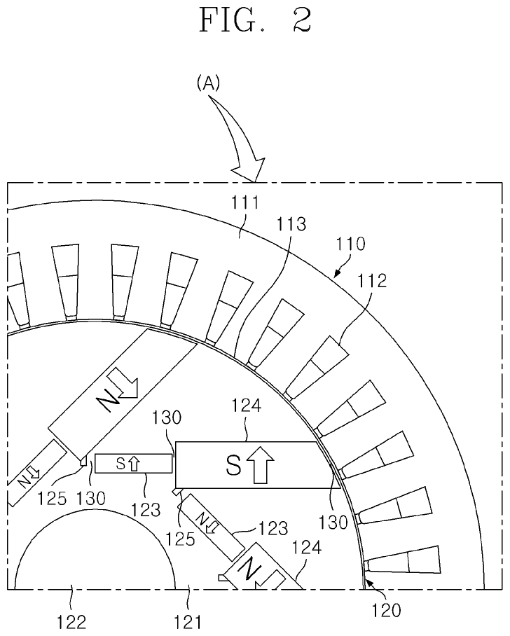

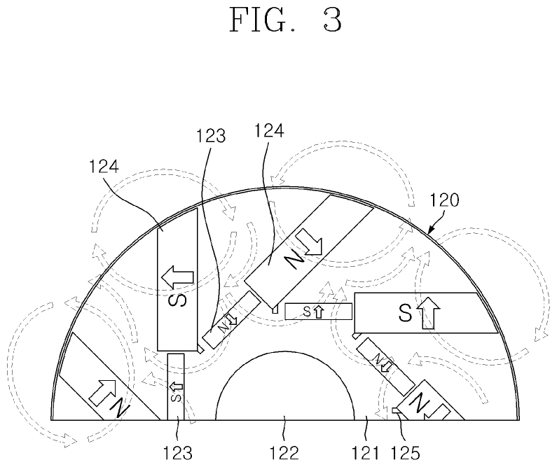

FIG. 1 is a view illustrating a configuration of a spoke motor according to an exemplary embodiment of the present invention which includes a combination of ferrite magnets and rare-earth magnets, FIG. 2 is an enlarged view of a partial region of the spoke motor according to the exemplary embodiment of the present invention which includes the combination of the ferrite magnets and the rare-earth magnets, and FIG. 3 is a view illustrating a magnetic flux loop of a magnetic circuit of the spoke motor according to the exemplary embodiment of the present invention which includes the combination of the ferrite magnets and the rare-earth magnets.

A spoke motor 100 according to an exemplary embodiment of the present invention includes a stator 110, a rotor 120 disposed inside the stator 100, and an air gap 113 between the rotor 120 and the stator 110.

The stator 110 has a stator core 111 and stator slots 112 that surround the rotor 120.

In the present invention, FIG. 1 illustrates a cross section of the spoke motor 100 using a combination of rare-earth magnets 123 and ferrite magnets 124.

The rotor 120 forms one motor pole by using the combination of the rare-earth magnet 123 and the ferrite magnet 124.

In the exemplary embodiment of the present invention, one rare-earth magnet 123 and one ferrite magnet 124 are disposed in a transverse direction on a rotor core 121 to form one motor pole (N-pole or S-pole).

In this case, the rare-earth magnet 123 is a magnet made of a rare-earth element and has residual magnetic flux three times that of a general magnet. The rare-earth magnet 123 is called an Nd magnet because the rare-earth magnet 123 uses neodymium (Nd).

The rare-earth magnet 123 is disposed adjacent to a central shaft 122 of the rotor 120, and the ferrite magnet 124 is disposed adjacent to a bridge 130, which is a space formed between the rotor 120 and the stator 110, thereby forming one motor pole.

The above-mentioned transverse direction means that the rare-earth magnet 123 and the ferrite magnet 124 are disposed in series.

The rare-earth magnet 123 has a smaller size than the ferrite magnet 124.

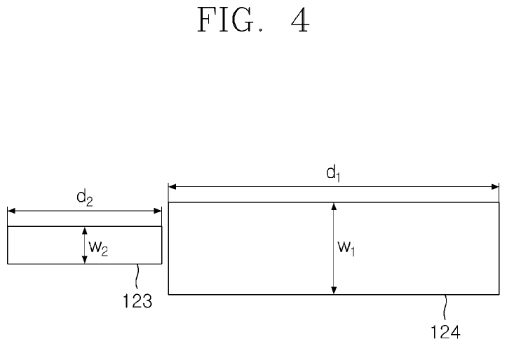

As illustrated in FIG. 4, with a distribution of a length d2 of the rare-earth magnet 123 and a length d1 of the ferrite magnet 124, the motor 100 according to the present invention may adjust the amount of magnetic flux of the magnet that affects an output of the motor 100.

The rare-earth magnet 123 and the ferrite magnet 124 may be designed such that a width w1 of the ferrite magnet/4<a width w2 of the rare-earth magnet<a width w1 of the ferrite magnet.

The rare-earth magnet 123 and the ferrite magnet 124 are disposed to be inclined at a predetermined angle with respect to the central shaft 122 of the rotor 120.

The rare-earth magnet 123 is disposed adjacent to the central shaft 122 of the rotor 120, and the ferrite magnet 124 is disposed adjacent to the air gap 113 which is a space formed between the rotor 120 and the stator 110.

In the rotor 120, the rare-earth magnet 123 having a small size is disposed close to the central shaft 122, such that the space of the rotor core 121 may be more efficiently used.

In the rotor 120, N-pole magnets and S-pole magnets, which are inclined at a predetermined angle with respect to the central shaft 122, are alternately arranged, thereby defining a shape such as a tornado shape.

The N-pole magnets and the S-pole magnets are formed by arranging the rare-earth magnets 123 and the ferrite magnets 124 in series in the transverse direction.

The above-mentioned structure, in which the rare-earth magnets 123 and the ferrite magnets 124 are arranged as described above, uses a smaller amount of Nd magnet 123 and a smaller number of bridges than a general IPM type motor, such that it is possible to exhibit excellent efficiency relative to the amount of used magnet.

Since the ferrite magnets 124 are arranged to be inclined at a predetermined angle with respect to the central shaft 122, a large amount of permanent magnet may be used and thus the spoke motor 100 may produce high torque.

The rare-earth magnets (Nd magnets) 123 are disposed adjacent to the central shaft 122, such that an efficient output may be produced relative to the amount of used magnet, and the magnetic leakage flux may be reduced.

In general, because the residual magnetic flux is large, the rare-earth magnet 123 is not demagnetized in the current and temperature regions when an appropriate width is maintained.

However, the ferrite magnet 124 may be easily demagnetized because the residual magnetic flux is only about ⅓ of the rare-earth magnet 123. Therefore, the width of the ferrite magnet 124 is greater than the width of the rare-earth magnet 123.

As illustrated in FIG. 3, according to the spoke motor 100 according to the present invention, the magnetic flux, which comes out of the ferrite magnet 124 and is directed toward the central shaft 122 of the rotor 120, is pushed toward the air gap 113 between the rotor 120 and the stator 110 by the rare-earth magnet 123, such that the magnetic flux density of the bridge 130 may be further increased, the magnetic leakage flux may be decreased, and a higher output may be produced.

A magnetic-flux-leakage preventing hole 125 is formed at one end of the ferrite magnet 124. The magnetic-flux-leakage preventing hole 125 has a predetermined shape and prevents demagnetization of the magnet or prevents magnetic leakage flux from the rare-earth magnet 123 and the ferrite magnet 124 when the motor 100 rotates at a high speed.

The magnetic-flux-leakage preventing hole 125 reduces magnetic leakage flux by means of a space through which no magnetic flux passes.

One surface of the magnetic-flux-leakage preventing hole 125 and an end surface of the rare-earth magnet 123 are in series with each other and form the bridge 130 which is a space made as one surface of the magnetic-flux-leakage preventing hole 125 and the end surface of the rare-earth magnet 123 are spaced apart from each other at a predetermined distance.

The bridge 130 makes it difficult for the magnetic flux, which comes out of the rare-earth magnet 123 and the ferrite magnet 124, to escape, and the bridge 130 forms a magnetic flux barrier, thereby minimizing the magnetic leakage flux.

The bridge 130 according to the present invention includes a space made as one surface of the magnetic-flux-leakage preventing hole 125 and the end surface of the rare-earth magnet 123 are spaced apart from each other at a predetermined distance, a space made as one end surface of the rare-earth magnet 123 and one end surface of the ferrite magnet 124 are spaced apart from each other at a predetermined distance, and a part of the rotor formed between one side end of the ferrite magnet 124 and an outer circumferential surface of the rotor.

In this case, as illustrated in FIG. 4, the bridges 130 may be designed such that the width w2 of the rare-earth magnet 123/10<the width of the bridge<the width w2 of the rare-earth magnet 123.

The rotor structure with many bridges 130 not only generates a large amount of magnetic leakage flux of the magnet of the rotor, and but also is greatly affected by centrifugal force generated during high-speed operation.

In contrast, since the bridges 130 are formed at three points in the present invention, it is possible to reduce the number of bridges in comparison with the IPM type motor, thereby improving efficiency of the magnet.

According to the present invention, the use of a small number of (three) bridges 130 and a small amount of rare-earth magnet 123 may greatly reduce manufacturing costs, produce an efficient output, and reduce magnetic leakage flux.

According to the present invention, the motor may produce a higher output than a spoke motor model using only the ferrite magnet, and the motor may use a smaller amount of rare-earth magnet than an IPM type motor model, but may produce an output at a similar level to that of the IPM type motor model.

The foregoing exemplary embodiments of the present invention are not implemented only by an apparatus and a method. Based on the above-mentioned descriptions of the exemplary embodiments, those skilled in the art to which the present invention pertains may easily realize the exemplary embodiments through programs for realizing functions corresponding to the configuration of the exemplary embodiment of the present invention or recording media on which the programs are recorded.

Although the exemplary embodiments of the present invention have been described in detail hereinabove, the right scope of the present invention is not limited thereto, and it should be clearly understood that many variations and modifications made by those skilled in the art using the basic concept of the present invention, which is defined in the following claims, will also belong to the right scope of the present invention.

What is claimed is:

1. A rotor for a spoke motor comprising:
a rotor core disposed in a stator; and
rare-earth magnets and ferrite magnets arranged in series in the rotor so as to be inclined at a predetermined angle with respect to a central shaft of the rotor core to form one motor pole,
wherein the rare-earth magnet is disposed adjacent to the central shaft, and the ferrite magnet is disposed adjacent to an air gap formed between the rotor and the stator,
wherein N-pole magnets or S-pole magnets, which are configured by the rare-earth magnets and the ferrite magnets of the rotor, are alternately arranged to have a tornado shape,
wherein the rare-earth magnet has a smaller size than the ferrite magnet, and
wherein a first bridge, which is a space made as one end surface of the rare-earth magnet and one end surface of the ferrite magnet are spaced apart from each other at a predetermined distance, is formed.

2. The rotor of claim 1, wherein a magnetic-flux-leakage preventing hole is formed at one end of the ferrite magnet having a first pole which is one of an N-pole and an S-pole, and the magnetic-flux-leakage preventing hole has a predetermined shape and prevents magnetic leakage flux or prevents demagnetization of the magnet,
wherein one surface of the magnetic-flux-leakage preventing hole and an end surface of the rare-earth magnet having a second pole opposite to the first pole are in series with each other and a second bridge, which is a space made as one surface of the magnetic-flux-leakage preventing hole and the end surface of the rare-earth magnet are spaced apart from each other at a predetermined distance, is formed, and
wherein a third bridge is formed between one end of the ferrite magnet and an outer circumferential surface of the rotor.

3. The rotor of claim 1, wherein the amount of magnetic flux of the magnet, which affects an output of the motor, is adjusted by means of a distribution of lengths of the rare-earth magnet and the ferrite magnet.

4. The rotor of claim 1, wherein the rare-earth magnet and the ferrite magnet are designed such that a width w1 of the ferrite magnet/4<a width w2 of the rare-earth magnet<a width w1 of the ferrite magnet.

5. The rotor of claim 1, wherein the bridges are designed such that a width w2 of the rare-earth magnet/10<a width of the bridge<a width w2 of the rare-earth magnet.
